(19) United States
(12) Patent Application Publication
(10) Pub. No.: US 2007/0174036 A1
(43) Pub. Date: Jul. 26, 2007

(54) Computer-implemented method, system and program product for emulating a topology of web services

(75) Inventors: David L. Schmidt, Cary, NC (US); Kyle L. Croutwater, Chapel Hill, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/340,130

(22) Filed: Jan. 26, 2006

(51) Int. Cl. G06F 9/455

(52) U.S. Cl. 703/26

(57) ABSTRACT

The present invention provides a computer-implemented method, system and program product for emulating a topology of web services. Specifically, under the present invention a set (e.g., one or more, preferably a plurality) of general purpose web services are deployed. Each general purpose web service includes a central processing unit emulator and a common interface. Moreover, each general purpose web service is capable of executing instructions for retrieving data and interacting with other general purpose web services. The topology of web services is then emulated using the set of general purpose web services by executing the instructions. Once the topology is emulated, it can be tested for accuracy, performance characteristics, etc.

### BACKGROUND OF THE INVENTION

1. Field of the Invention

The present invention generally relates to web services. Specifically, the present invention relates to the emulation of a topology of web services using a set of general purpose web services.

2. Related Art

Testing topologies of web services requires time consuming and difficult setup work. Specifically, as known, a web service is a program that can receive input, perform some service and provide output. One example of a web service function is when a web user desires to know a particular stock price/quote. In such an instance, a “quotation” web service will receive the stock symbol from the web user, obtain the current stock quote, and then output the quote to the web user. Many Information Technology (IT) infrastructures create topologies of web services by interconnecting multiple individual web services. That is, the individual web services are programmed to perform some action (such as described above), and to call other web services to perform additional actions.

Unfortunately, testing such topologies can be a difficult task. Currently, software exists that attempts to manage the servers on which these web services reside. Part of what this software-does is to graphically depict the interaction between individual web services. What current technology fails to provide however, is a way to test this software to ensure it correctly reflects interaction of web services, the topology would survive under load, etc. Part of the problem is that it is difficult to replicate/emulate customer environments such as large retail operations due to the many pieces that need to be in place.

### SUMMARY OF THE INVENTION

In general, the present invention provides a computer-implemented method, system and program product for emulating a topology of web services. Specifically, under the present invention a set (e.g., one or more, preferably a plurality) of general purpose web services are deployed. Each general purpose web service includes a central processing unit emulator and a common interface. Moreover, each general purpose web service is capable of executing instructions for retrieving data and interacting with other general purpose web services. The topology of web services is then emulated using the set of general purpose web services by executing the instructions. Once the topology is emulated, it can be tested for accuracy, performance characteristics, etc.

A first aspect of the present invention provides a computer-implemented method for emulating a topology of web services, comprising: deploying a set of general purpose web services, wherein each of the set of general purpose web services is capable of executing instructions that set forth interactions between one another; and emulating the topology of web services using the set of general purpose web services based upon execution of the instructions.

A second aspect of the present invention provides a system for emulating a topology of web services, comprising: a deployment system for deploying a set of general purpose web services, wherein each of the set of general purpose web services is capable of executing instructions that set forth interactions between one another; and an emulation system for emulating the topology of web services using the set of general purpose web services based upon execution of the instructions.

A third aspect of the present invention provides a program product stored on a computer useable medium for emulating a topology of web services, the computer useable medium comprising program code for causing a computer system to perform the following steps: deploying a set of general purpose web services, wherein each of the set of general purpose web services is capable of executing instructions that set forth interactions between one another; and emulating the topology of web services using the set of general purpose web services based upon execution of the instructions.

A fourth aspect of the present invention provides a method for deploying an application for emulating a topology of web services, comprising: deploying a computer infrastructure being operable to: deploy a set of general purpose web services, wherein each of the set of general purpose web services is capable of executing instructions that set forth interactions between one another; and emulate the topology of web services using the set of general purpose web services based upon execution of the instructions.

A fifth aspect of the present invention provides computer software embodied in a propagated signal for emulating a topology of web services, the computer software comprising instructions for causing a computer system to perform the following steps: deploying a set of general purpose web services, wherein each of the set of general purpose web services is capable of executing instructions that set forth interactions between one another; and emulating the topology of web services using the set of general purpose web services based upon execution of the instructions.

Therefore, the present invention provides a computer-implemented method, system and program product for emulating a topology of web services.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 depicts a system for emulating a topology of web services according to the present invention.

FIG. 2 depicts a flow diagram according to the present invention.

It is noted that the drawings of the invention are not to scale. The drawings are intended to depict only typical aspects of the invention, and therefore should not be considered as limiting the scope of the invention. In the drawings, like numbering represents like elements.

### DETAILED DESCRIPTION OF THE INVENTION

As indicated above, the present invention provides a computer-implemented method, system and program product for emulating a topology of web services. Specifically, under the present invention a set (e.g., one or more, preferably a plurality) of general purpose web services are deployed. Each general purpose web service includes a central processing unit emulator and a common interface. Moreover, each general purpose web service is capable of executing instructions for retrieving data and interacting with other general purpose web services. The topology of web services is then emulated using the set of general purpose web services by executing the instructions. Once the topology is emulated, it can be tested for accuracy, performance characteristics, etc.

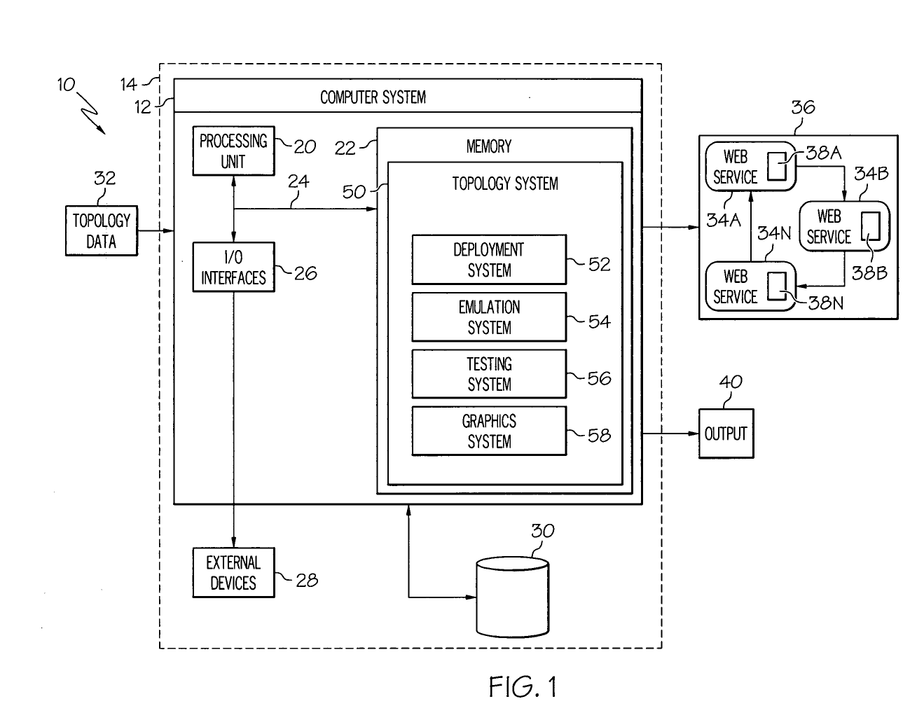

Referring now to FIG. 1, a system 10 for emulating a topology of web services according to the present invention is shown. As depicted, system 10 includes a computer system 12 deployed within a computer infrastructure 14. It should be understood that computer system 12 is intended to represent any type of system capable of emulating a topology of web services in accordance with the present invention. As such, the present invention could be implemented on a stand-alone computer system 12 as shown, or within a larger computer network (e.g., a wide area network (WAN), a local area network (LAN), a virtual private network (VPN), etc.) that utilizes any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, some or all of the components of system 10 (e.g., those within infrastructure 14) could be deployed, managed, serviced, etc. by a service provider who offers to emulate a topology of web services.

As shown, computer system 14 includes a processing unit 20, a memory 22, a bus 24, and input/output (I/O) interfaces 26. Further, computer system 12 is shown in communication with external I/O devices/resources 28 and storage system 30. In general, processing unit 20 executes computer program code, such as topology system 50, which is stored in memory 22 and/or storage system 30. While executing computer program code, processing unit 20 can read and/or write data to/from memory 22, storage system 30, and/or I/O interfaces 26. Bus 24 provides a communication link between each of the components in computer system 12. External devices 28 can comprise any devices (e.g., keyboard, pointing device, display, etc.) that enable a user to interact with computer system 12 and/or any devices (e.g., network card, modem, etc.) that enable computer system 12 to communicate with one or more other computing devices.

Computer system 12 is only representative of various possible computer systems that can include numerous combinations of hardware. To this extent, in other embodiments, computer system 12 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in computer system 12. However, if computer system 12 comprises a handheld device or the like, it is understood that one or more external devices 28 (e.g., a display) and/or storage system(s) 26 could be contained within computer system 12, not externally as shown.

Storage system 30 can be any type of system (e.g., a repository) capable of providing storage for information under the present invention such as instructions, testing data, topology graphics, etc. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 12.

Shown in memory 22 of computer system 12 is topology system 50, which is a software program that will provide the functions of the present invention, and which includes deployment system 52, emulation system 54, testing system 56, and graphics system 58. In general, these systems represent program code that carries out the steps of the present invention as described above. Specifically, assume that a certain topology of web services is desired to be emulated and tested. As indicated above, a web service will typically receive some user input (e.g., a stock symbol), perform some function (e.g., obtain a price quote for the corresponding stock), and then provide output (e.g., the price quote) to the user. In many cases, a particular IT infrastructure will deploy a series of web services that are adapted to communicate with one another (referred to herein as a topology of web services). For example, web service “A” might obtain some piece of data and communicate the same to web service “B”, which then performs additional processing. In such instances, proper testing of the topology can be a challenge.

Under the present invention a topology of web services can be emulated and tested. Specifically, using topology data 32, deployment system 52 will deploy a set (e.g., one or more, but preferable more than one) of web services 34A-N and interrelate the same. In a typical embodiment, web services 34A-N are general purpose web services that each have a common interface. Moreover, topology data 32 should be understood to include parameters and/or descriptions for the various web services 34A-N, as well as instructions for the web services 34A-N to carry out. Such instructions should define the operations that the web services 34A-N will perform (e.g., data to obtain and/or to process) as well as interactions (e.g., communication flows) between the web services 34A-N. Topology data 32 can be provided as input as shown, or accessed by topology system 50 from another location.

In any event, in deploying web services 34A-N based on topology data 32, deployment system 52 can be programmed to deploy each web service 34A-N from a library of web services, to customize existing web services, and/or to create new web services. Once web services 34A-N are deployed, emulation system 54 will emulate a topology 36 using web services 34A-N by causing web services 34A-N to execute the instructions contained in topology data 32. This will result in web services 34A-N performing their intended functions and communicating with one another as they would in the topology that is being emulated. It should be understood that web services 34A-N will typically include a processing unit emulator 38A-N (e.g., CPU emulator) for executing the instructions.

After the instructions are executed, topology 36 will represent an emulation of topology that is desired to be tested. At this point, testing system 56 can test topology 36 in any number of ways. For example, testing system 56 can exercise loads (e.g., network), etc. on web services 34A-N and monitor the resulting performance. As such, testing system 56 can incorporate any testing software now known or later developed. Graphics system 58 can provide any output 40 that is desired. For example, graphics system 58 can provide a graphical representation of topology 36, test results, etc.

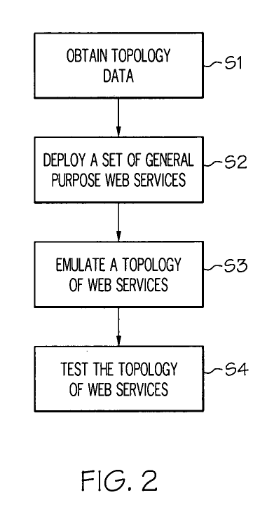

Referring now to FIG. 2, a method flow diagram according to the present invention is shown. As shown, first step S1 is to obtain topology data for a topology of web services to be emulated. Second step S2 is to deploy a set of general purpose web services. As indicated above, each of the set of general purpose web services includes a processing unit emulator that is capable of executing instructions contained in the topology data, and includes a common interface. Third step S3 is to emulate the topology of web services using the set of general purpose web services by executing the instructions. Fourth step S4 is to test the topology of web services after the topology has been emulated.

While shown and described herein as a method and system emulating a topology of web services, it is understood that the invention further provides various alternative embodiments. For example, in one embodiment, the invention provides a computer-readable/useable medium that includes computer program-code to enable a computer infrastructure to emulate a topology of web services. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 22 and/or storage system 30 (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to emulate a topology of web services. In this case, the service provider can create, maintain, support, etc., a computer infrastructure, that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for emulating a topology of web services. In this case, a computer infrastructure, can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 12, from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A computer-implemented method for emulating a topology of web services, comprising:
deploying a set of general purpose web services, wherein each of the set of general purpose web services is capable of executing instructions that set forth interactions between one another; and
emulating the topology of web services using the set of general purpose web services based upon execution of the instructions.

2. The computer-implemented method of claim 1, further comprising testing the topology of web services after the emulating.

3. The computer-implemented method of claim 2, the testing comprising exercising a network load on the emulated topology of web services.

4. The computer-implemented method of claim 1, wherein the instructions further set forth data to be retrieved by the set of general purpose web services.

5. The computer-implemented method of claim 1, each of the set of general purposes including a common interface.

6. The computer-implemented method of claim 1, each of the set of general purpose web services including a central processing unit emulator to execute the instructions.

7. The computer-implemented method of claim 1, further comprising generating a graphical representation of the topology of web services.

8. A system for emulating a topology of web services, comprising:
a deployment system for deploying a set of general purpose web services, wherein each of the set of general purpose web services is capable of executing instructions that set forth interactions between one another; and
an emulation system for emulating the topology of web services using the set of general purpose web services based upon execution of the instructions.

9. The system of claim 8, further comprising a testing system for testing the topology of web services after the emulating.

10. The system of claim 9, the testing system exercising a network load on the emulated topology of web services.

11. The system of claim 8, wherein the instructions further set forth data to be retrieved by the set of general purpose web services.

12. The system of claim 8, each of the set of general purposes including a common interface.

13. The system of claim 8, each of the set of general purpose web services including a central processing unit emulator to execute the instructions.

14. The system of claim 8, further comprising a graphics system for generating a graphical representation of the topology of web services.

15. A program product stored on a computer useable medium for emulating a topology of web services, the computer useable medium comprising program code for causing a computer system to perform the following steps:
deploying a set of general purpose web services, wherein each of the set of general purpose web services is capable of executing instructions that set forth interactions between one another; and
emulating the topology of web services using the set of general purpose web services based upon execution of the instructions.

16. The program product of claim 15, the computer useable medium further comprising program code for causing the computer system to perform the following step: testing the topology of web services after the emulating.

17. The program product of claim 16, the computer useable medium further comprising program code for causing the computer system to perform the following step: exercising a network load on the emulated topology of web services.

18. The program product of claim 15, wherein the instructions further set forth data to be retrieved by the set of general purpose web services.

19. The program product of claim 15, each of the set of general purposes including a common interface.

20. The program product of claim 15, each of the set of general purpose web services including a central processing unit emulator to execute the instructions.

21. The program product of claim 15, the computer useable medium further comprising program code for causing the computer system to perform the following step: generating a graphical representation of the topology of web services.

22. A method for deploying an application for emulating a topology of web services, comprising:
deploying a computer infrastructure being operable to:
deploy a set of general purpose web services, wherein each of the set of general purpose web services is capable of executing instructions that set forth interactions between one another; and
emulate the topology of web services using the set of general purpose web services based upon execution of the instructions.
